(19) United States
(12) Patent Application Publication
(10) Pub. No.: US 2003/0109172 A1
(43) Pub. Date: Jun. 12, 2003

(54) Electrical access system and method

(75) Inventors: Glen Foden, Toronto (CA); Lloyd Nelson, Little Britain (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Camino Modular, Toronto (CA)

(21) Appl. No.: 10/266,927

(22) Filed: Oct. 9, 2002

Related U.S. Application Data
(60) Provisional application No. 60/327,304, filed on Oct. 9, 2001.

(51) Int. Cl. H01R 13/60

(52) U.S. Cl. 439/535

(57) ABSTRACT

An electrical access system and method for providing access to an electrical receptacle at a panel is described. The electrical access system can be mounted in an aperture of an access floor panel comprising a housing for holding electrical receptacles attached to cables running underneath the access floor system and a support integral with or supportable on an access floor panel. The housing may be removably attached to the support in a position whereby equipment above the access floor panel may be connected to the receptacles through the aperture. The housing may be attached to or removed from the support without disconnecting the cables, and moved below the access floor panel away from the access floor panel to another location.

### FIELD OF THE INVENTION

The invention relates to access panel systems, and more specifically to electrical access systems for access panel systems.

### BACKGROUND OF THE INVENTION

Access floor panel systems are typically employed in an office where frequent rewiring of conduits and cables is necessary when the office is rearranged. These conduits and cables may be for any utility, such as, for example, electrical power, data transmission and fiber optic transmission. Access floor panel systems, such as those used in an office setting, include floor panels that are raised above a hidden subfloor. The cables and conduits can be placed in the space between the floor panel and the subfloor. Access floor panel systems simplify both the initial installation of cables in an office and any subsequent modification or rearrangement thereof.

Electrical access systems are utilized in access floor panel systems to provide access to various ports and outlets connected to the cables. Electrical access systems typically employ a floor mounted electrical box to connect the conduits and cables beneath the floor to equipment above the floor. To install the electrical box, a rectangular hole is cut out in a floor panel. The electrical box has a flange, which abuts the top surface of the floor when the electrical box is lowered into the hole. The conduits and cables are typically routed beneath the floor and attached to plugs or receptacles through the bottom of the electrical box. The tops of the plugs or receptacles can be accessed from above the floor. For example, a cover at the floor surface may be opened to provide access to the receptacle in the electrical box.

When rewiring of an office is necessary, portions of the access floor can be removed to expose the conduits and cables beneath the floor. The wiring for each conduit and cable must then be removed from an electrical box and rerouted to a different electrical box, or to the same electrical box after it has been moved to a new location. This is typically a relatively difficult and time consuming task, as there may be numerous connections to the electrical box that must be removed, rerouted and reattached. An additional drawback mentioned above is that a rectangular hole needs to be cut out in the floor panel to insert the electrical box.

There are known systems which provide a plug and socket system for connecting cables to electrical boxes, thus a socket is mounted on the box and connected internally to the different components within the electrical box, while a plug can be mounted on a cable. These plug and socket systems can accommodate a variety of different electrical services. Such an arrangement is acceptable in many jurisdictions and can enable electrical boxes to be freely disconnected, moved around and rearranged, without requiring any highly skilled labor. However, in many jurisdictions, at least in North America, local regulations prohibit the use of these plug and socket arrangements. Accordingly, in such jurisdictions, it is still necessary to provide a hard-wired connection to each electrical box. This in turn means that, if an electrical box is to be moved, utilizing known electrical box designs, the electrical cables have to be disconnected and reconnected, which in turn means that a qualified electrician must be employed. This is both expensive and inconvenient, particularly where electrical outlets may need to be arranged relatively frequently, to accommodate changes in an office layout.

### SUMMARY OF THE INVENTION

An electrical access system for use in an access panel system is described. In one example, the access panel system is an access floor system as might be used in an office. Other examples include an access wall system, and an access ceiling system. The electrical access system can include a housing for holding various receptacles attached to cables running underneath the access floor panel and a support integral with or supportable on an access floor panel. The housing may be removably attached to the support in a position whereby devices above the access floor panel may be connected to the receptacles through an aperture. The housing may be attached to or removed from the support without disconnecting the cables, and moved below the access floor panel away from the access floor panel to another location. An embodiment has a support that rests on the top surface of an access floor panel and has a portion extending into the aperture. The portion extending into the aperture can include pins, which engage with bayonet slots in the housing.

In particular, a system for providing access at a panel, such as a floor panel, to an electrical receptacle, such as an outlet for accepting an electrical plug, is provided herein. The system includes a support affixed to the panel, and a housing for securing an electrical receptacle connected to a cable. The housing is removably attached to the support, and can be removed from the support without disconnecting the cable from the electrical receptacle.

Also described herein is a method for providing access to an electrical receptacle at a panel. The method includes affixing a support to the panel, connecting a cable to an electrical receptacle, and securing the electrical receptacle to a housing. The method also includes removably attaching the housing to the support. The housing can be removed from the support without disconnecting the cable from the electrical receptacle.

The method can also include affixing a second support to the panel, removing the housing from the first support without disconnecting the cable from the electrical receptacle, and removably attaching the housing to the second support.

Also described herein is a circular system for providing access to an electrical receptacle at a panel where the system includes a support affixed to the panel, and a housing attached to the support for securing an electrical receptacle. The perimeter of a projection of at least one of the support and the housing of the circular system is substantially a circle. In one embodiment, the circle has a diameter of about eight inches.

### BRIEF DESCRIPTION OF THE DRAWINGS

For a better understanding of the present invention and to show more clearly how it may be carried into effect, reference will now be made, by way of example only, to the accompanying drawings which show embodiments of the present invention as follows.

FIG. 1 is an exploded perspective view of an electrical access system, according to a first aspect of the present invention.

FIG. 2 shows the electrical access system, assembled and with a power plate cover open;

FIG. 3 is a cross-sectional view in a vertical plane of the electrical acces system of FIGS. 1 and 2;

FIGS. 4, 5 and 6 show perspective views of an access floor system incorporating the electrical access system of the present invention;

FIG. 7 is an exploded perspective view of an electrical access system according to a second embodiment of the present invention;

FIG. 8 is a view similar to FIG. 2, showing a variant of a cover plate assembly;

FIG. 9 is a view similar to FIG. 8, showing a closure plate in an open position;

FIG. 10 is a cross-sectional view in a vertical plane of the electrical access system of FIGS. 8 and 9, showing a hinge mechanism of the variant of the cover plate assembly; and

FIG. 11 is a perspective view of an electrical access system of the present invention incorporating a protective cover.

### DETAILED DESCRIPTION OF THE INVENTION

The electrical access system described herein provides access to an electrical receptacle at a panel of an access panel system. The electrical access system can be mounted in a hole cut out in a panel of the access panel system, and can serve as a means to connect data or power lines to devices, such as computers, above the access panel system.

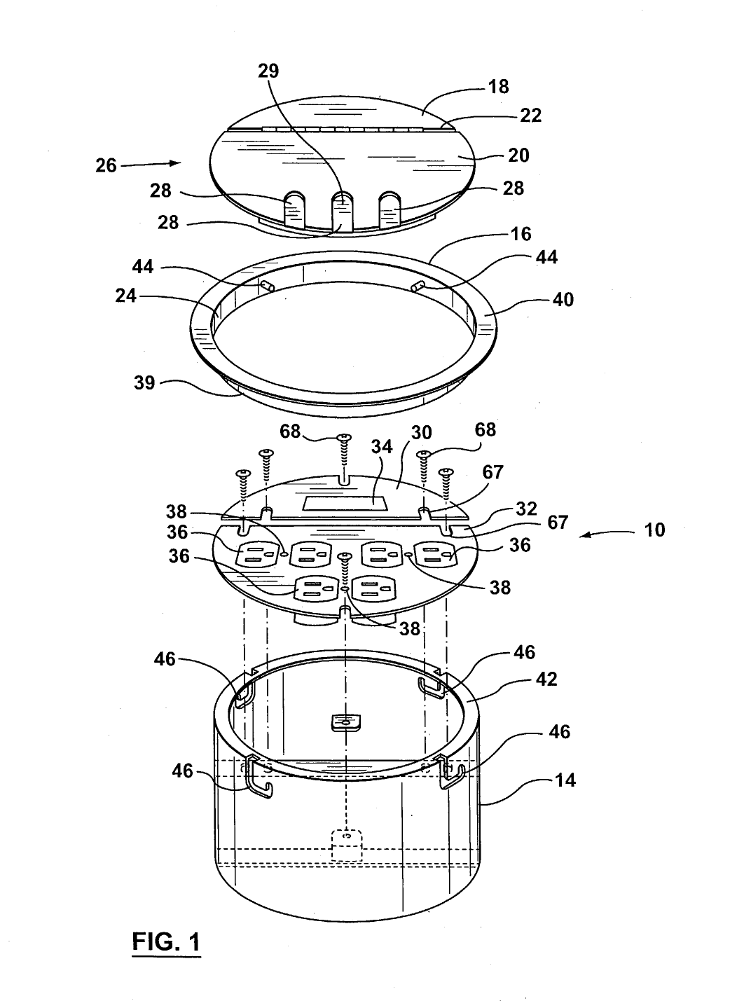

FIG. 1 shows an electrical access system 10 for providing access to an electrical receptacle, such as an electrical outlet, at a panel (not shown), such as a floor panel. The system 10 includes a support 16 that is affixed to, or mounted in, an aperture in, the panel, and a housing 14. The support 16 can include an inner surface 24, a cylindrical portion 39, a peripheral edge 40 and pins 44, and the housing 14 can include slots, such as bayonet slots 46, and an upper flange 42. The system 10 also includes a cover plate assembly 26 having a data plate cover 18 and a power plate cover 20, covering a data plate 30 and a power plate 32. The housing 14, the support 16, the data and power plates 30, 32 and the cover plate assembly are preferably all made of steel.

The housing 14 functions to secure one or more electrical receptacles, such as a duplex receptacle 36, connected to a cable (not shown). For this purpose, the data plate 30, the power plate 32, a connection opening 34, and a receptacle fastener 38 may be used, as shown in FIG. 1. The housing 14 is removably attached to the support 16. The electrical access system 10 provides access to the electrical receptacles after the power plate cover 20 is opened by rotation about a cover hinge 22. As described in more detail below, the housing 14 can be removed from the support 16 without disconnecting the cable from the electrical receptacle 36.

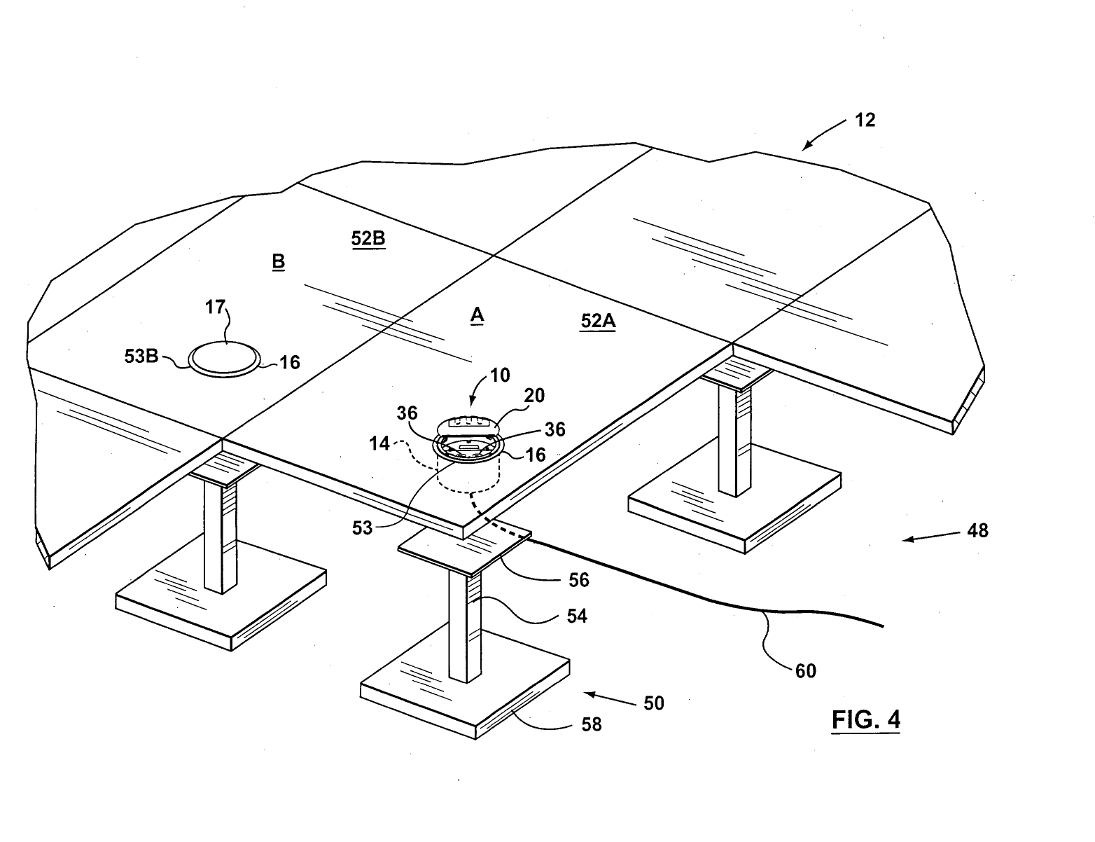

The support 16 has a generally cylindrical portion 39 and a wide, ring-shaped peripheral edge 40. The cylindrical portion 39 has an inner surface 24 that is generally cylindrical with a diameter larger than the diameter of at least an upper portion of the housing 14 so as to permit sliding engagement of the housing 14 into the support 16. The peripheral edge 40 portion of the support 16 is large enough to project radially around the circumference of the housing 14 to mount the support 16 on the top of an access floor panel 52 around the edge of an aperture 53 (FIG. 4) in the access floor panel 52. From the inner surface 24 of the cylindrical portion 39 a series of pins 44 extend radially inwardly. A corresponding series of bayonet slots 46 are formed on the exterior of the housing 14. The pins 44 are aligned with the bayonet slots 46 to removably connect the box support 16 with the housing 14. By vertical and rotational movements of the housing 14, it may be engaged with or disengaged from the pins 44.

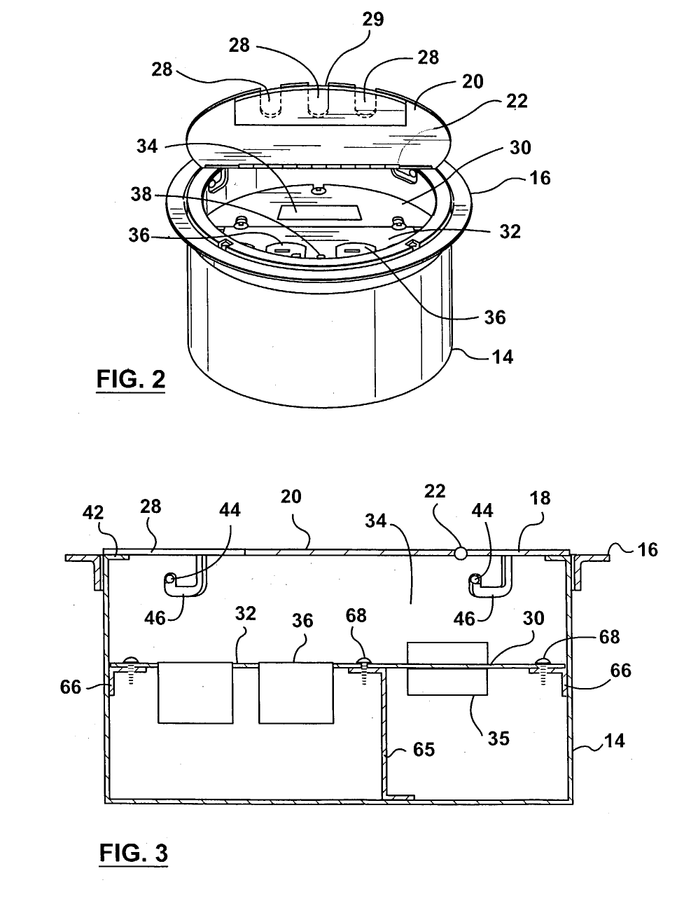

Referring to FIG. 2, an assembled electrical access system is shown with the power plate cover 20 open. The cover hinge 22 supports the power plate cover 20 for pivotal movement into and out of a closed position. The power plate cover 20 is configured to provide access to the duplex receptacles 36 and the connection opening 34. When the power plate cover 20 is in the open position, as shown in FIG. 2, it exposes the power and data plates 30,32, with the three duplex receptacles 36 and the connection opening 34 (only the plate 30 and receptacles 36 being shown in FIG. 2).

In one embodiment, the housing 14 is cylindrical and may be made from a number of materials, but is preferably made out of steel. The housing 14 includes an upper flange 42 extending radially inwardly, and as shown the slots 46 extend into the flange 42, to permit the pins 44 to pass. The cover plate assembly 26 sits flush with the top of the support 16, and the data cover plate 18 is secured to the flange 42 in known manner. As described above, the cover plate assembly 26 includes the data plate cover 18 and the power plate cover 20. The data plate cover 18 and the power plate cover 20 are preferably formed of steel but may be made from a number of materials and may be made in a wide variety of configurations, is detailed further below. These plate covers 18 and 20 are connected by a cover hinge 22 so that the power plate cover 20 may be opened to access the inside of the housing 14. The power plate cover 20 includes cable openings 28 to permit cords, cables etc. to enter the electrical access system 10 from devices above the access floor system.

The cable openings 28 are provided with a cover sheet 29, secured to the power plate cover 20. This cover sheet 29 is formed from a resilient material and can be provided with slots, corresponding to the cable openings 28. Thus, when not in use, with the power plate cover 20 closed, the cover sheet 29 serves to ensure that the openings 28 are substantially closed, thereby to prevent or at least hinder debris and dirt falling into the housing 14 and contaminating the duplex receptacles, etc. In use, after power cords and the like have been connected to a duplex receptacle 36 or data jacks 35, as required, the cables are located passing through the openings and through the slots in the cover sheet 29. The cover sheet 29 thus then tends to enclose the cables to the greatest extent possible, again tending to prevent ingress of debris, dirt, etc.

The data plate 30 includes a connection opening 34 that can be employed as a mounting facility for standard data and fiber optic transmission connectors or jacks 35, including, for example, standard jacks for telephone or audio lines. The power plate 32 includes mounting facilities for a plurality of duplex receptacles 36 for delivery of electrical power. The duplex receptacles 36 are connected to the power plate 32 using a plurality of receptacle fasteners 38, e.g. screws in known manner. The data plate 30 and power plate 32 are mounted inside of and recessed from the top of the electrical access system 10 to provide a space or chamber under the plate covers 18,20 for plugs that are connected to the duplex receptacles 36 or any the tallest of any other connections to any other form of receptacle that may optionally be employed on a plate, such as the power plate 30 or data plate 32. For example, sufficient space may be provided for a standard plug attached to the end of an electrical power cord to stand upright into the duplex receptacle 36 without protruding above the top of the electrical access system 10.

Within the housing 14, there is a Z-shaped bracket 65 secured to the bottom of the housing 14, and on either side of the bracket 65, L-shaped shaped tabs 66 secured to sidewalls of the housing 14. This bracket 65 and tabs 66 provide mountings for the data plate 30 and the power plate 32. As indicated, these plates 30, 32 can include slots 67 for screws or other fasteners 68 to secure them to the bracket 65 and L-shaped tabs 66.

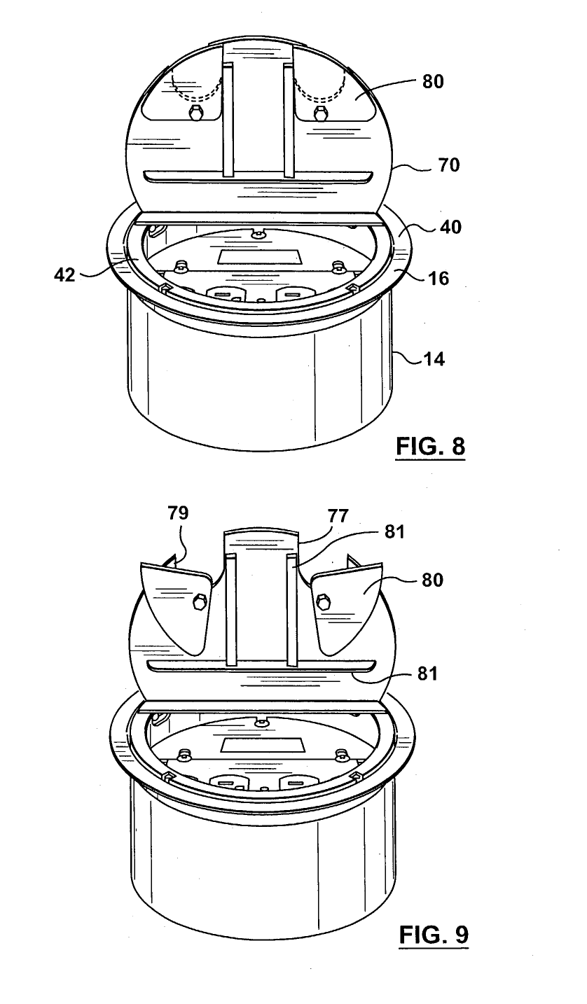

Reference will now be made to FIGS. 8-10, which show an alternative design of the cover plate assembly 26, here indicated by the reference 70. A data cover plate 72 is secured to the flange 42 around the top of the housing 14. This data cover plate 72 is formed from sheet steel and includes a flange 73 step down from the main portion of the main data cover plate 72 by an amount approximately equal to the thickness of the steel plate used. This flange 73 includes a slot 74. A power plate cover 75 includes a pivot portion 76 inclined at an angle to the main portion of the power plate cover 75. A securing tab 77 extends from the pivot portion 76, and is generally parallel to the main portion of the power plate cover 75, with the pivot portion 76 extending at an angle thereto, as indicated. A fastener, such as a screw or rivet 78 is provided in the securing tab 77. During assembly, the securing tab 77 is inserted through the slot 74, and then the fastener 78 is inserted into a preformed hole in the securing tab 77, thereby to prevent removal of the power plate cover 75.

The dimensions of the power plate 75 and the slot 74 are such that it can be freely pivoted in the slot 74 between open and closed positions. In a closed position, the main portion of the power plate cover 75 is generally coplanar with the main portion of the data cover plate 72, so as to present a uniform, flat upper surface. The power plate cover 75 can be pivoted to an open position, through the more than 90°, so that it is stable in the open position, to permit plugs and cables to be readily inserted and connected, or disconnected, as required.

As shown, two relatively large slots for cables are provided at 79, and pivoted closure plates 80 are provided. As shown in FIGS. 8 and 9, the closure plates 80 can be pivoted between open and closed positions as required. If desired, a resilient cover sheet, similar to sheet 29 can be provided. Reinforcing ribs 81 are also provided.

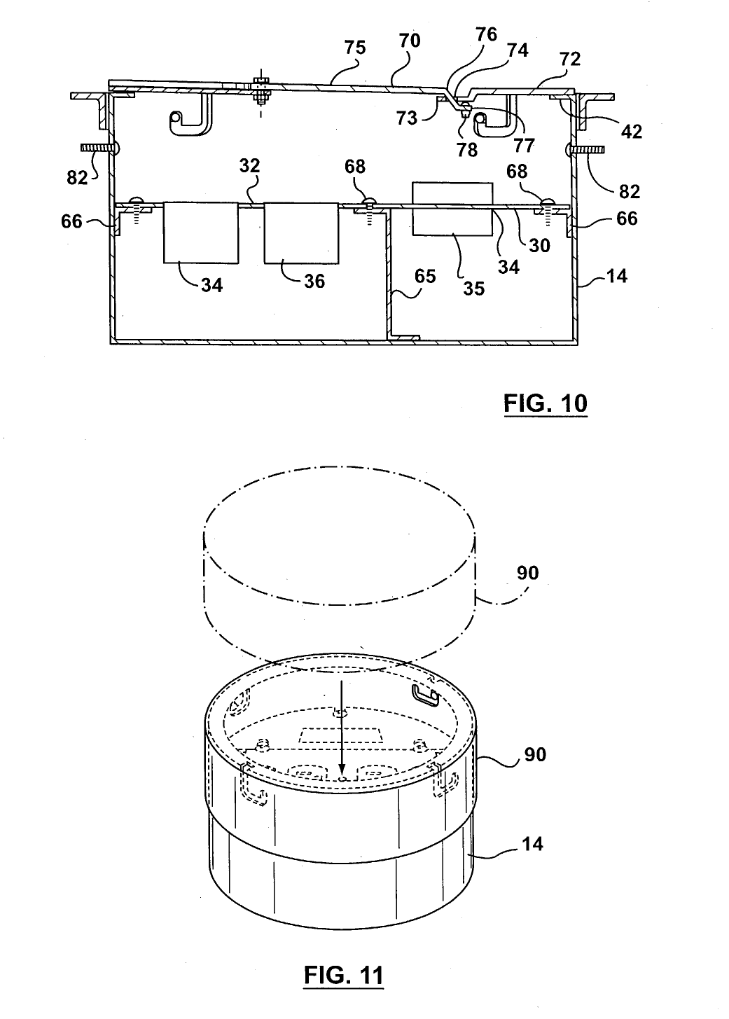

With reference now to FIG. 10, to prevent accidental or unintended removal of the system 10 and in particular of the housing 14, it is preferred to provide a number of screws or other fastener elements adjacent the upper end of the housing 14. These are positioned with respect to the expected depth or thickness of floor panels 52, i.e., so that the screws or fasteners, indicated at 82 would extend just below the floor panels 52. In use, these fasteners 82 will normally be provided extending rigidly out from the housing 14 as shown. This then prevents removal of the housing 14 with the support 16, by simply lifting the entire system 10 vertically upwards. Whenever it is desired to remove a particular housing 14 entirely, by pulling it up through one of the apertures 53, then the screws 82 can be withdrawn radially inwards.

Although not shown, it will be understood that the bottom or sides of the housing 14 would be provided with suitable access holes or openings for cables to connected to the receptacles 36, data jacks, etc. As is well known for electrical outlet boxes, these holes could either be preformed, or they could be in the form of holes that are partly precut, leaving the holes closed by a circular portion of the body 14, but ready for this portion to be punched out to open the hole as required. During installation, electricians simply punch out those holes that are needed for that particular installation. It is also possible that some holes could be provided either already completely cutout or partly cutout, together with some cover plate that would be removed in use, again as required

It is anticipated that, in a large installation, including a large number of systems 10 installed in an access floor system 12 (FIGS. 4-6), there will be occasions that not all the systems 10, i.e., not all the floor outlets, will be required. In such cases, rather than disconnect the unused systems 10, which would require the costs of a skilled electrician, the unused systems 10 can be left below the floor system 12, covered by the floor panels 52 (i.e., floor panels without any apertures). The unused systems 10 would then simply be located on the sub floor 48. While the cover plate assemblies 26, 70 will provide some protection to the housings 14, the slots 46 will still leave the housings open to some extent. In many cases, regulations will require that such unused housings 14 be entirely closed, both for safety reasons, and to prevent ingress of dirt and debris over time, which could contaminate the receptacles, etc., within them. For this purpose, the present invention also provides a protective cover 90 (FIG. 11). Like the housings 14, the cover 90 could be formed of sheet steel, by spinning, and could be dimensioned to form a close sliding fit over the exterior of the housing 14. For some applications, it may be desirable to provide pins on the inside of the cover 90 (not shown), to engage the bayonet slots 46, however, for most applications, it is anticipated that a plain cover 90 that simply slips over the housing 14 will be sufficient, as the covered housing 14 will be entirely covered by the floor panels 52 and will otherwise be inaccessible.

Referring to FIG. 4, an electrical access system 10 mounted to an access floor system 12 is shown. The access floor system 12 has access floor panels 52 raised above a subfloor 48 to provide space for a bundle of cables 60. The cables 60 may comprise electrical power, data transmission and fiber optic transmission wiring. A series of pedestals 50 support the access floor panels 52. The pedestals 50 include a vertical support post 54, a panel support piece 56 and a foot 58. Individual access floor panels 52 are supported on the corners by the panel support piece 56. Alternate support mechanisms for the access floor panels may also be used. A single system 10 is shown, but it will be understood that, although not shown, such installations commonly would have numerous outlets, switches and systems 10 providing floor-mounted outlets, etc.

The electrical access system 10 is located on the access floor system 12 at position A where a special access floor panel 52A having an aperture 53 is located. A support 16 rests on the top of the access floor panel 52A and protrudes into its aperture 53. The power plate cover 20 is pivoted in the open position revealing the power plate 32 and the three duplex receptacles 36. The housing 14 is attached to and extends downwardly from the support 16. More specifically, the housing 14 is supported by the peripheral edge 40 portion of the support 16, which extends into the aperture of the access floor panel 52A.

FIG. 4 also shows a second optional access floor panel 52B at position B. The second support 16 is also mounted in the second panel 52B in a respective aperture 53B. This second support 16 is not provided with a housing 14 but is ready to receive the housing 14, when the housing 14 is moved from position A. As shown, without a full system 10, it includes just a temporary closure 17.

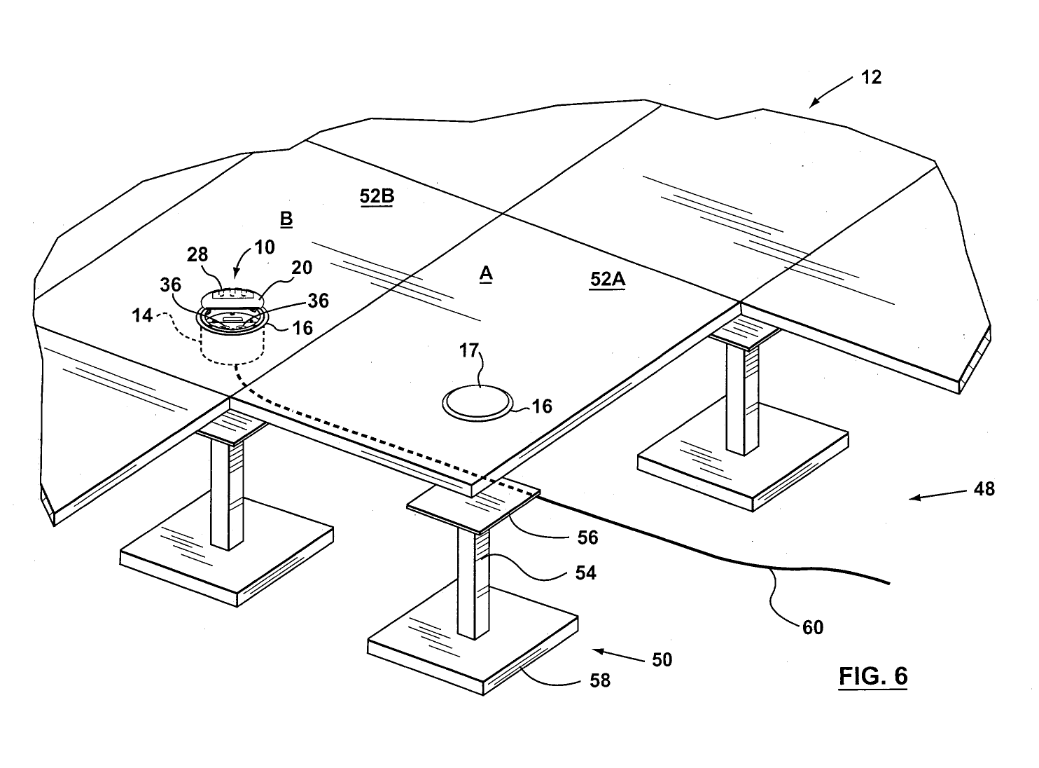

When the access floor system 12 is originally installed, cables 60 are wired to the housing 14 of the electrical access system 10. According to the principles of the present invention, the housing 14 can be removed from the first support of panel 52A and removably attached to the second support of panel 52B without disconnecting the cable 60 from the electrical receptacle 36. More generally, the housing 14 can be moved to any position on the access floor system 12 without the need for disconnecting the cable 60. When an office or computer room etc. is to be rearranged, the housing 14 is disconnected from the support 16 by moving the housing 14 so that the pins 44 travel along the bayonet slots 46 until they are free of the slots 46. The closure 17 can then be moved to the first support 16 (FIG. 6).

In effect, as a support 16 and a housing 14 are separable, the housing 14 can be disconnected from the support 16 and then freely moved beneath the floor system 12. The support 16, on the other hand, as it has the peripheral edge 40 cannot be passed through the opening 53, to a position underneath the floor; the support 16 is therefore lifted out of the aperture 53 and freely moved above the floor system 12.

In contrast, known, floor-mounted outlets have a housing and support that are integral with one another. As the support always has some form of support flange, this necessarily means that the entire outlet must be lifted out of the aperture and moved above the floor system 12, which in turn requires that any cables connected to the outlet or its housing be disconnected and reconnected.

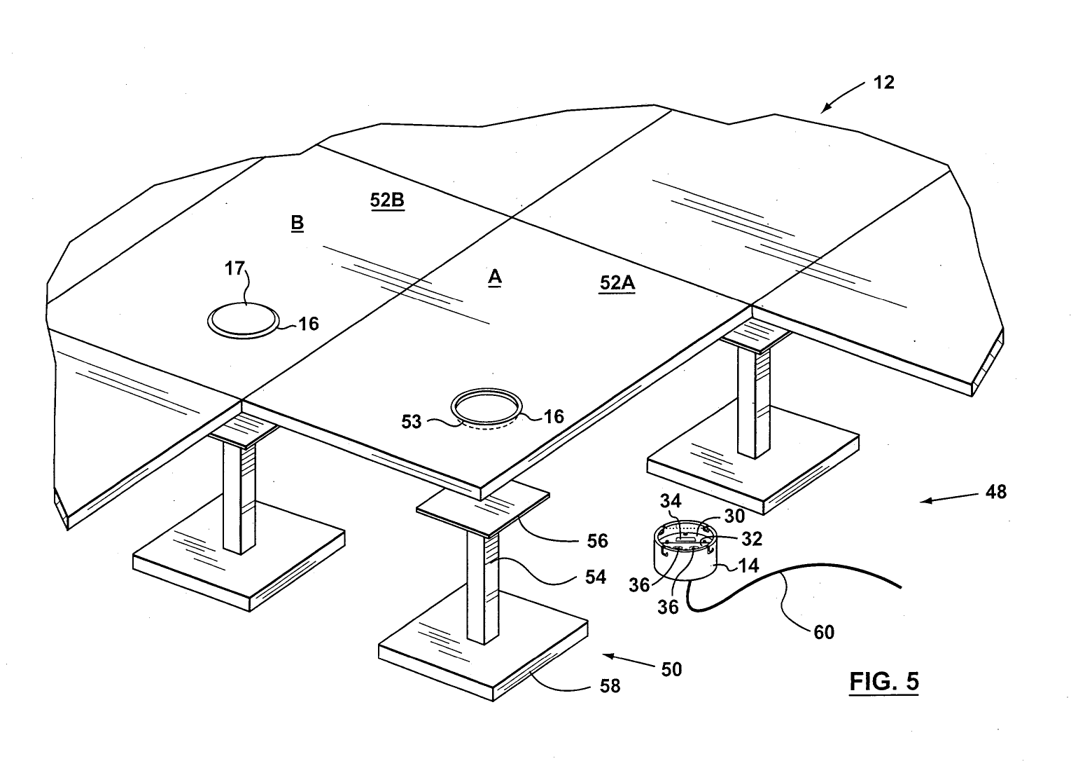

FIG. 5 shows the electrical access system 10 mounted to the access floor system 12 with the housing 14 disconnected from the support 16. The cable 60 remains attached to the housing 14 and connected to the cable 60, while the support 16 remains positioned on the access floor panel 52A.

To provide electrical power and data connections to a different location on the access floor system 12, such as location B, the housing 14 is moved beneath the access floor system 12 to position B. In position B, openings to the housing 14 are aligned with the pins 44 in a support 16, and the housing 14 is moved vertically and rotated until the housing 14 is supported by the pins 44 at location B, to form a supported system 10 at the location B.

FIG. 6 shows the electrical access system 10 mounted to the access floor system 12 with the housing 14 in its new location at position B. The power plate cover 20 is in the open position revealing the power plate 32 and the three duplex receptacles 36. In this manner, the housing 14 can be removed from the first support 16 at position A, and removably attached to the second support 16 at position B without disconnecting the cable 60 from the electrical receptacle 36.

Optionally, instead of providing a second access floor panel 52B with an aperture and a second support 16, the first access floor panel 52A with its aperture 53 and support 16 and plate covers 18,20 may be moved to position B. A standard access floor panel located at position B is then moved to position A. Thus, the electrical access system 10 provides outlets that can be moved anywhere without requiring multiple special access floor panels 52 with apertures and multiple supports 16.

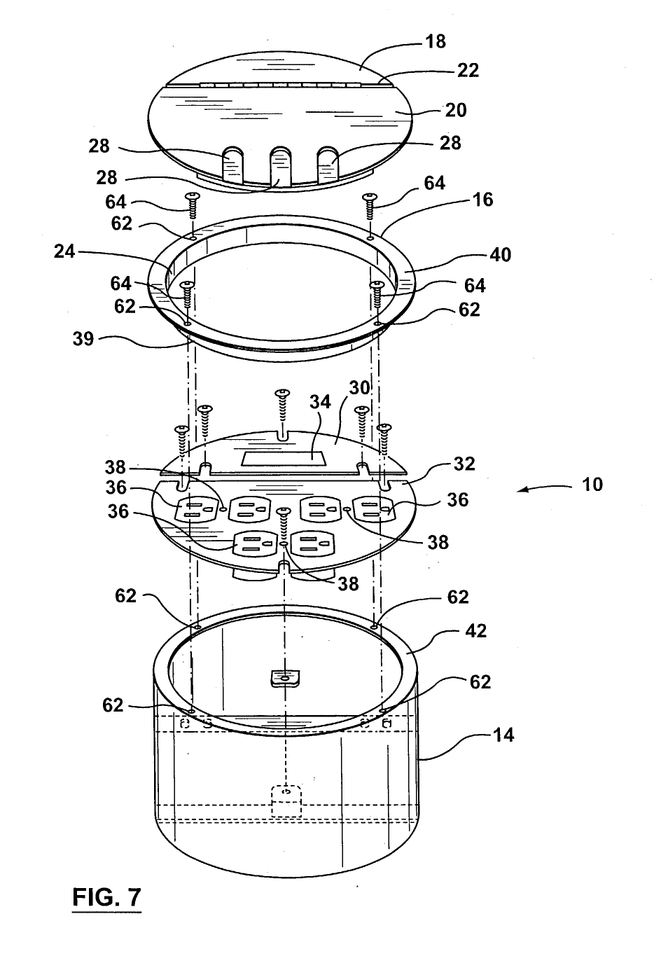

Another embodiment of the electrical access system is shown in FIG. 7. The support 16 and the upper flange 42 of the housing 14 have apertures 62 for receiving fasteners 64 that fasten the support 16 to the housing 14. The fasteners 64 can be screws or more quickly removable fasteners, such as cam hooks, a shaft with a rectangular head that engages a rectangular slot with a one-quarter turn, or a shaft with a head engaging a keyhole slot. These slots may be located either on the housing 14 or the support 16. The upper edge of the support 16 is wide enough to extend beyond the outside of the housing 14 to provide a surface to bear on the topside of an access floor panel 52, and simultaneously extends across the top of the flange 42; for this purpose, the support 16 can include a flange extending radially inwardly, from the cylindrical portion 39 and corresponding to the upper flange 42.

Because the housing is removably attached to the support, the housing can be removed from the support without disconnecting the cable from the electrical receptacle. This feature results in a savings of time and money. Additionally, the embodiment highlighted above in which the electrical access system is cylindrical affords additional advantages. Heating, ventilation and air conditioning (HVAC) systems also require that a hole be cut into the floor panel, typically of an eight-inch diameter, for ducts and the like. In fact, floor panels are sometimes manufactured with holes to accept HVAC equipment. Thus, if a cylindrical electrical access system is employed, the need to cut a circular hole in the floor panel may be obviated if an already existing HVAC opening in the panel is used for the electrical access system of the present invention.

It should be understood that various modifications could be made to the embodiments described and illustrated herein, without departing from the present invention, the scope of which is defined in the appended claims. For example, although access floor systems have been emphasized, the principles of the present invention can also be used in access wall or ceiling systems.

Also, the support 16 can be integral with access panel 52. This could be done, for example, by permanently attaching the support 16 to an access floor panel, or by installing pins 44 directly into an aperture of an access floor panel. Further, other support mechanisms could be used. For example, pins may be provided on the housing 14 and mate with one or more slots in a modified support, access floor panel, or a plate suspended from an access floor panel. Further, the housing 14 might have a ridge containing a keyhole slot that removably engages a headed protrusion from a modified flange or access floor panel. Further, the housing 14, the support 16, etc. need not be round. For example, the housing 14 could be rectangular and the flange 14 also made rectangular but larger in one direction. Thus, translational movements could be used instead of rotational movements to install or remove the housing 14. With the embodiment of FIG. 9, almost any shape of housing 14 can be used. Other sorts of connection devices that require the support 16 and the housing 14 to be lifted above the access floor panel system 52 slightly, such as a screw through the sides of the support 16 into the housing 14, may be used.

While the invention has been described with the support having a relatively shallow vertical dimension and the housing having a relatively large vertical dimension and comprising the larger part of the overall system, this ratio of relative dimensions and sizes could vary significantly. For example, the support could extend downwardly through the aperture to a greater extent, and the housing can be correspondingly smaller. More significantly, at least part of the plates providing access to the duplex receptacles, communication ports and the like, and defining a chamber for plugs etc., could be formed with the support so as to be integral therewith and to be removed with the support. In effect, there would be a plate extending across the bottom of an extended support. The “housing” would then be smaller and comprise at least one element actually having the individual receptacles, data communication ports mounted in it, which would then be mountable or connectable to the bottom of the support. Such a variant for the housing would still embody the key aspect of the invention, namely that the support and housing would be seperable, for the support to be mounted to a panel from one side of the panel and the housing to be engaged with the support from the other side of the panel.

1. A system for mounting in a panel and for providing access to a receptacle, the system comprising:
a support for mounting in the panel, on one side of the panel; and
a housing providing a mounting for the receptacle for connection of the receptacle to a cable, the housing being removably attachable to the support from the other side of the panel, whereby, in use, with a receptacle mounted on the housing and a cable attached to the receptacle, the housing can be removed from the support without disconnecting the cable from the receptacle.

2. The system of claim 1, wherein the support and the housing include complementary engagement means.

3. The system of claim 2, wherein the complimentary engagement means comprises a plurality of pins provided on one of the support and the housing, and a plurality of slots provided on the other of the support and the housing.

4. The system of claim 3, wherein the support and the housing include cylindrical surfaces that slidingly engage one another and wherein the pins are provided extending radially between the support and the housing.

5. The system of claim 4, wherein the support includes a cylindrical inner surface and wherein the pins are provided extending radially inwards from the cylindrical cover surface, and wherein the housing includes a plurality of slots for engaging the pins.

6. The system of claim 2, wherein the complementary engagement means comprises a plurality of screws engaging complementary threaded bores provided in one of the support and the housing.

7. The system of claim 2, wherein the support includes a peripheral edge for engaging said one side of the panel, to support the system.

8. The system of claim 7, wherein the support includes a portion for extending at least partially through the aperture in a panel.

9. The system of claim 8, wherein said portion is cylindrical and provides a cylindrical inner surface.

10. The system of claim 7, wherein one of the support and the housing provides a recessed access plate provided below the peripheral edge of the support and defining a chamber for accommodating plugs engaging said at least one receptacle, wherein the housing provides a mounting for at least one receptacle, and the access plate provides access to each receptacle.

11. The system of claim 10, including a cover plate assembly mounted to the support, for closing off the chamber, the cover plate assembly including at least one hinged closure, providing access to the chamber and said at least one receptacle.

12. The system of claim 11, wherein the closure includes at least one slot for accommodating cables extending into the chamber when the hinged closure is in a closed position.

13. The system of claim 12, wherein the access plate forms part of the housing and also provides a mounting for each receptacle.

14. The system of claim 12, wherein the access plate forms part of the support.

15. The system of claim 12, wherein said at least one receptacle comprises at least one of:
an electrical receptacle for a power supply;
a data communication connector; and
a fiber optic transmission connector.

16. The system of claim 15, wherein said at least one receptacle includes at least one receptacle for a power supply and at least one data transmission connector.

17. The system of claim 15, wherein all of the receptacles are mounted to the housing at the bottom of said chamber.

18. The system of claim 4, wherein the outer diameter of the system, below the peripheral edge of the support, is substantially 8 inches.

19. The system of claim 13, wherein the housing is substantially cylindrical, and includes internal support elements providing support for the access plate providing a mounting for each receptacle.

20. The system of claim 1 including a protective cover for the housing, for protecting the housing when removed from the support.

21. In combination, an access floor system including a plurality of panels and a plurality of apertures in the panels;
at least one access system comprising a support mounted in an aperture of one of the panels; and a housing removably attached to the support and including a mounting for at least one receptacle; and
at least one receptacle mounted in the housing, wherein the support is mounted to the floor panel from one side thereof and the housing is removably attachable to the support from the other side of the floor panel, whereby, in use, the housing, with at least one receptacle mounted thereto and with a cable attached to the receptacle, is removable from the support, for movement to another aperture and for attachment to a support provided in other aperture.

22. A method for providing access to an electrical receptacle at a panel, the method comprising the steps of:
providing an aperture in the panel;
mounting a support to the aperture in the panel from one side of the panel;
providing a housing including a mounting for at least one receptacle, and providing at least one receptacle secured to the housing;
connecting a cable to said at least one receptacle; and
removably attaching the housing to the support from the other side of the panel, wherein the housing can be removed from the support without disconnecting the cable from the electrical receptacle.

23. The method of claim 22, which includes providing the aperture with a circular section and providing the support and the housing with complementary cylindrical surfaces.

24. The method of claim 23, including providing the aperture with a diameter of eight inches.

25. The method of claim 22, further comprising the steps of:
providing a second aperture in said panel or in another panel;
mounting a second support to the second aperture from said one side of the panel;
after the step of attaching the housing to the first-mentioned support, removing the housing from the first-mentioned support without disconnecting the cable from the electrical receptacle; and
removably attaching the housing to the second support.

26. The method of claim 22, wherein the step of removably attaching includes engaging pins in the support with slots in the housing.

27. The method of claim 22, wherein the step of removably attaching includes engaging slots in the support with pins in the housing.

28. The method of claim 22, including providing said at least one receptacle as at least one of:
an electrical receptacle for a power supply;
a receptacle with data communication ports; and
a receptacle with optical fiber communication ports.

29. The method of claim 28, wherein the step of securing includes mounting each receptacle to a mounting plate.

30. The method of claim 29, further comprising the step of providing a cover plate assembly including at least one hinged closure, and displacing the closure to an open position to connect cables to each receptacle and closing the closure to cover and to protect the receptacles.
